(19) United States
(12) Patent Application Publication
(10) Pub. No.: US 2006/0257682 A1
(43) Pub. Date: Nov. 16, 2006

(54) Corrosion protection of galvanized steel using a cerium salt-based solution and detection of the amount of corrosion resistance enhancement

(76) Inventors: Yon-Kyun Song, Torrance, CA (US); Florian Mansfeld, Marina del Rey, CA (US)

Correspondence Address: FISH & RICHARDSON, PC, P.O. BOX 1022, MINNEAPOLIS, MN, 55440-1022, US

(21) Appl. No.: 11/362,434

(22) Filed: Feb. 24, 2006

Related U.S. Application Data
(60) Provisional application No. 60/656,235, filed on Feb. 24, 2005.

(51) Int. Cl. C25D 5/10; C23F 3/00; B32B 9/00

(52) U.S. Cl. 428/658; 428/697; 428/621; 428/687

(57) ABSTRACT

Processing a galvanized metal using a cerium nitrate solution. The cerium nitrate is used to add cerium to a surface of the galvanized metal. Hydrogen peroxide, colloidal silica and silene may be added to the solution that is applied to the surface of the metal. This can reduce the corrosion reaction, thereby improving corrosion resistance. In an embodiment, the processing is carried out by dipping the metal into the solution for 60 seconds or less, followed by drying for 10 seconds or less, for a total processing time of 70 seconds or less.

### CROSS-REFERENCE TO RELATED APPLICATIONS

This application claims priority to U.S. Provisional Application Ser. No. 60/656,235, filed on Feb. 24, 2005. The disclosure of the prior application is considered part of (and is incorporated by reference in) the disclosure of this application.

### BACKGROUND

Metals are conventionally used in locations where they can be corroded. Different kinds of corrosion protection are known.

One form of protection of metals, for example aluminum and/or galvanized steel, includes hexavalent chromium ions. However, hexavalent chromium ions may cause certain kinds of environmental problems.

In addition, fast treatment of metals is desirable for industrial applications.

### SUMMARY

The present disclosure describes different kinds of cerium containing coatings on different kinds of galvanized steel sheets formed on steel underlays. Specific compositions of coatings and techniques of forming the coatings are described. An aspect includes treating the materials with Cerium Nitrate.

In addition, techniques for characterizing the corrosion resistance of the coated materials are described.

### BRIEF DESCRIPTION OF THE DRAWINGS

In the Drawings:

FIG. 1 illustrates a typical determination using the characterization program;

FIGS. 2A and 2B show the equivalent circuit as well as fit results for the galvanized metal;

FIGS. 3A and 3B show an equivalent circuit and fit results for a treated EG material;

FIGS. 4A and 4B show equivalent circuit and fit results for EN and GA galvanized metals;

FIG. 5 illustrates a time dependence between the bare and treated samples;

FIG. 6 illustrates dynamic curves for the samples;

FIG. 7 illustrates polarization curves;

FIGS. 8A, 8B, 9A and 9B illustrate bode plots;

FIG. 10 illustrates time dependence for the different samples;

FIGS. 11A-11D illustrate time dependence for different samples;

FIGS. 12A and 12B show scanning electron microscope images samples treated; and

FIGS. 13A and 13B show depth profiling results.

### DETAILED DESCRIPTION

In the embodiments disclosed herein, metal substrates are formed of either electroplated zinc, electroplated Zn—Ni, and hot dipped Zn or Zn—Fe sheets. A material is used as the coating material.

In this embodiment the galvanized sheets are immersed in a solution of 10 mM Ce(NO₃)₃.6H₂O for 30 minutes, or more generally, into any solution of cerium nitrate or any cerium salt. The embodiments describe the characteristics of the coated metal materials. The characteristics can be evaluated for example, by electrochemical methods such as polarization curves, electrochemical impedance spectroscopy (EIS), or other techniques. The chemical composition of the coating layers may be analyzed using x-ray photoelectron spectroscopy. The relationship between corrosion resistance and chemical composition of the coating layers is analyzed.

Another embodiment adds H₂O₂, colloidal silicate and silane to the basic cerium salt solution.

In the embodiments, the substrates used are commercial products, available from Pohang Iron and Steel Co. of South Korea.

The electroplated zinc layer on cold rolled steel, which has the designation of EG, has a coating weight of 20 grams/m² and a thickness of about 5 μm.

The electroplated zinc-15 wt % nickel layer on cold rolled steel, designated as EN, has a coating weight of 20 g/m² and a thickness of about 5 μm.

The hot dipped zinc-12 wt % iron-0.3 wt %-aluminum layer on cold rolled steel, designated as GA has a coating weight of 80 g/m² and a thickness of about 15 μm.

Other comparable materials are available from other vendors, having different designations and different exact compositions.

These materials, and other analogous materials, are being used in corrosive environments. Zinc-nickel, for example, has been widely used to protect steel automobile bodies from perforation corrosion caused by salts and dirty water that can remain in hidden zones within the automobiles.

More generally the galvanized metal materials can have a nickel content within a Zn layer which is controlled to be between 11 and 15 wt %, with a coating thickness of about 5 μm. Zn—Ni galvanized steel has certain advantageous characteristics: it shows good corrosion performance, good weldability, and paintability.

The GA material is produced by an iron diffusion process. During the production of this material, the steel strip is passed through a molten zinc pot, and then aged in a furnace to allow the iron to diffuse from the steel substrate into the remaining material. The coating layer contain small amounts of aluminum, for example 0.10-0.12 wt %. The coating layer may also include up to 14 wt % Fe. This specific kind of galvanized steel provides good weldability for parts of automotive bodies.

In operation, the samples are first treated in a cleaning solution such as alconox to remove surface contamination. The materials are then immersed in 7.5 wt % HCl for 10 seconds, and then rinsed thoroughly in pure water.

The pretreated substrates are immersed in the basic cerium nitrate solution for 30 minutes at room temperature. The materials are then rinsed in pure water and dried by blowing air.

The testing of the materials allows determination of the different kinds of characteristics that the materials possess. In an embodiment, treated samples with an exposed area of 4.9 cm square are mounted in a three-electrode electrochemical cell. A stainless steel electrode is used as a counter electrode, while a saturated calomel electrode (SCE) is used as the reference electrode. The analysis compares the corrosion behavior of bare and treated samples exposed to a corrosive environment. In the embodiment, the corrosive environment is 0.5 N NaCl open to air. Corrosion behavior is analyzed using EIS and polarization measurements. Impedance spectra of the exposed samples are recorded as a function of exposure time at the corrosion potential E_{corr} in a frequency range between 10⁵ and 5 10⁻³ hertz using an applied AC signal of 10 mV. The spectra are then analyzed using appropriate equivalent circuits. The equivalent circuits may include a one-time constant model or a coating model combined with an open boundary finite length diffusion element.

After recording the impedance spectrum, a potential sweep is carried out with a scan rate of 0.167 mV per second over the potential range between −30 mV and +30 mV from E_{corr}. Then, the polarization curves are analyzed using software such as the POLFIT software that determines values of anodic Tafel slope bₐ, as well as cathodic Tafel slope b_{c}, and also determines the corrosion density i_{corr}.

A value B=bₐb_{c}/2.3(bₐ+b_{c}) is used to convert the polarization resistance values obtained from analysis of the impedance spectrum into the corrosion current density.

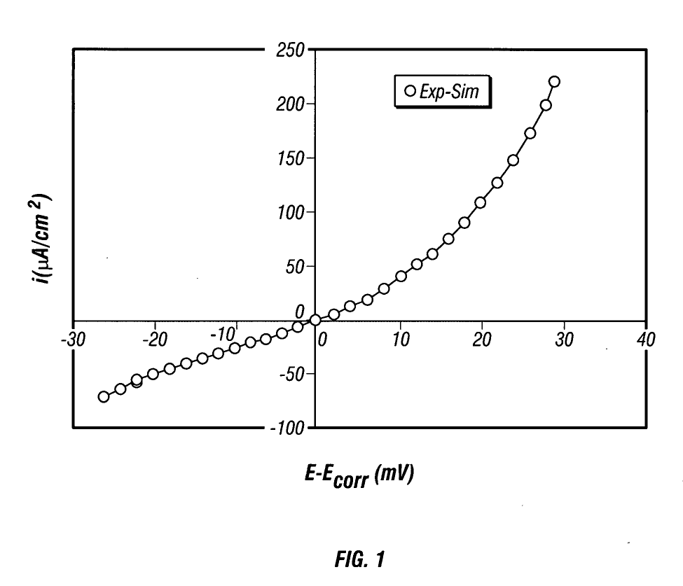

The POLFIT program allows calculation of i_{corr}, bₐ, b_{c}, and B with their corresponding error terms as well as the statistical quality of the fit. Typical results for experimental and fitted data are shown in FIG. 1. Corrosion current densities, Tafel slopes and the protection efficiency
P(%)=(1−i_{corr}/i_{corr}^{o})*100,
where i_{corr} is corrosion current density of the treated sample and i_{corr}^{o} is the corrosion current density of the bare sample, are listed in Table I.

The corrosion current densities, i^{o}_{corr}, of the three bare samples have different values. The bare EN has the lowest of value i^{o}_{corr} which indicates that the corrosion resistance of electroplated Zn is drastically improved by alloying with Ni. Preferential dissolution of zinc at the start of corrosion offers good galvanic protection, which leads to Ni enrichment of the gamma-phase (Ni₅Zn₂₁) acting as an effective corrosion barrier. In the case of hot dipped Zn—Fe (GA), Fe provides a similar corrosion protection effect as Ni. For treated samples similar low i_{corr} values are observed for EN and EG with somewhat higher values for GA. E_{corr} values are the lowest for bare and treated EG and the highest values for the Zn—Ni sample (see Table I).

The ranking of the corrosion protection property based on i_{corr} values for treated samples was found to be EN>EG>GA, while the ranking for bare samples was found to be EN>GA>EG. This suggests that treatment in the cerium salt solution is most useful for EG for which P=95.8% was obtained.

On the other hand, for EN, which already has low corrosion rates without the treatment, P was only 62.4%.

These results demonstrate the important realization that the surface chemistry of the galvanized steel plays an important role in the corrosion resistance of the bare samples and the efficiency of treatment processes. Many of the techniques disclosed herein enable varying the treatment that is used based on the surface chemistry.

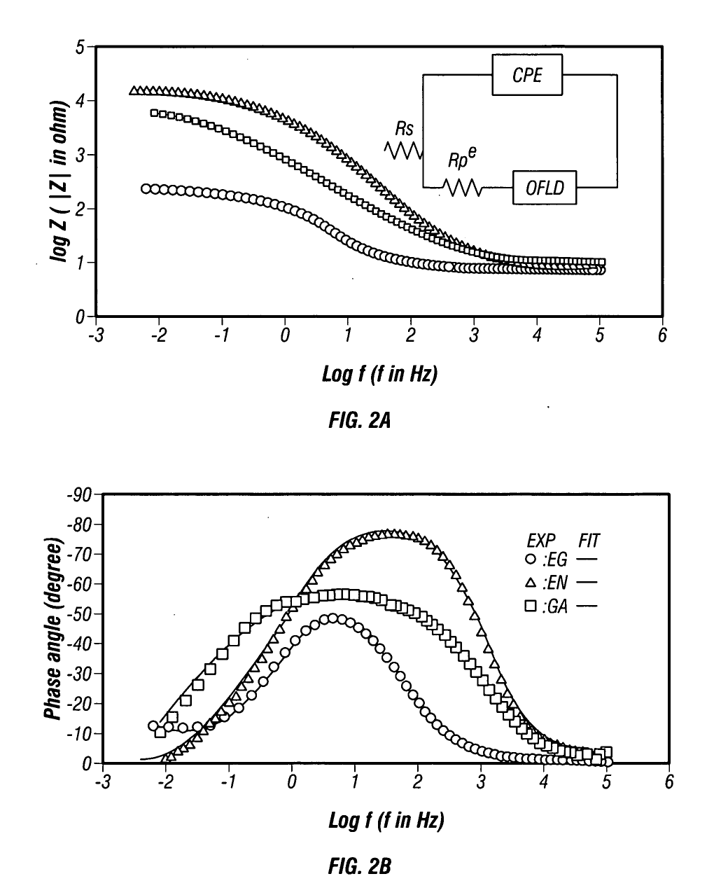

Bode plots and ECs used for the analysis of the impedance spectra for three bare samples exposed to 0.5N NaCl for 1 day are shown in FIG. 2. The EC in FIG. 2a has a constant phase element (CPE) and the open boundary finite length diffusion (OFLD) element used to analyze the impedance spectra the untreated samples. The impedance Z(ZPE) of the CPE is given by:
Z(ZPE)=Y−¹ₒ(jω)⁻ⁿ (1).

The dimension of Yₒ, is sⁿ/ohm, while that of a capacitance C is s/ohm. A simple R—C circuit shows how to convert experimental values of Yₒ, into C values. More complicated circuits may be converted in an analogous way. The experimental and fit results are shown in FIGS. 2a and 2b for the three bare samples. The CPE is in parallel with the polarization resistance Rₚ^{e} which is in series with the OFLD element that models the diffusion impedance when the diffusion layer has finite dimension. For the bare samples, it may be assumed that the porous corrosion product layer acts as the diffusion layer. Using Boukamp's notation, the impedance of the OFLD element is given by:
Z_{OFLD}={tanh(B_{d}(jω)^{1/2})}/Y^{d}_{O}(ω)^{1/2} (2)
where B_{d}=1/(D)^{1/2} is the diffusion parameter, I is the diffusion length, D is the diffusion coefficient and Y^{d}_{O}=(σ(2)^{1/2})⁻¹. For coated samples, I equals the coating thickness. The Warburg coefficient σ, which is a function of D and the concentration of the diffusing species as well as the exposed area, has the dimension ohm.cm²(sec)^{-1/2}. For infinite values of I the EC in FIG. 2a becomes the Randles circuit, in which the Warburg impedance Z_{w} is in series with Rₚ^{e} and is given by
Z_{w}=s(l−j)ω^{-1/2} (3)

The results of the analysis of impedance spectra of the bare samples exposed to 0.5 NaCl for 24 hrs are shown in Table II. The ranking based on Rₚ^{e} for the three samples is EN>GA>EG which is the same as the ranking based on i_{corr} values in Table I. The corrosion c. d., i^{e}_{corr}=B/Rₚ^{e} values obtained by analyses of the impedance spectra are similar to i_{corr} obtained by POLFIT. The σ and B_{d} values for bare samples show similar trends as the i_{corr} values. Since the Warburg coefficient depends on the exposed area, it can be concluded that the porosity of the corrosion product layers is the highest for EG and the lowest for EN. Based on the B_{d} values one can similarly conclude that the corrosion product layer is the thickest for EG and the thinnest for EN (see Table II).

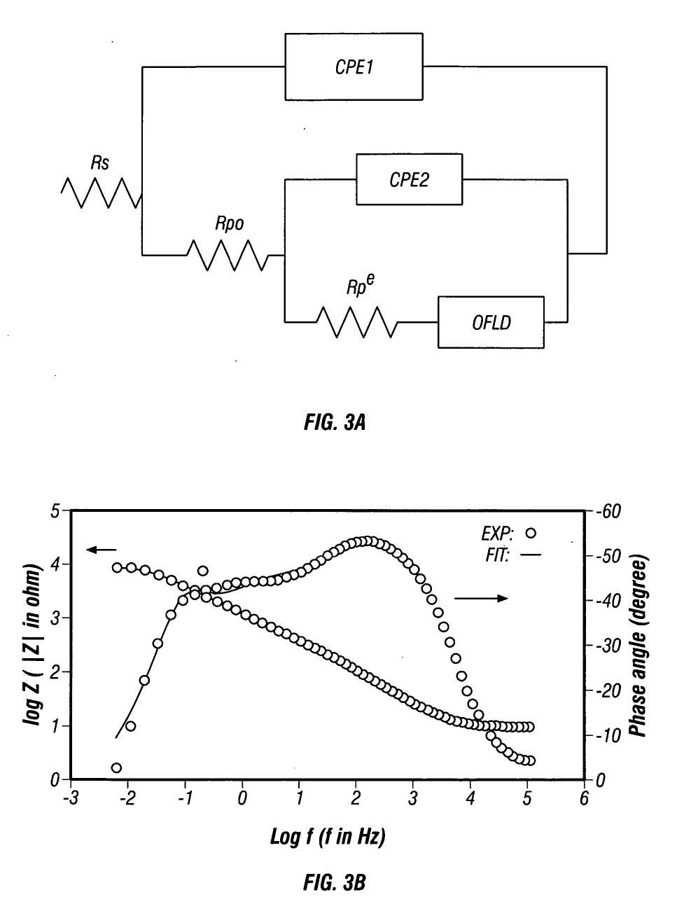

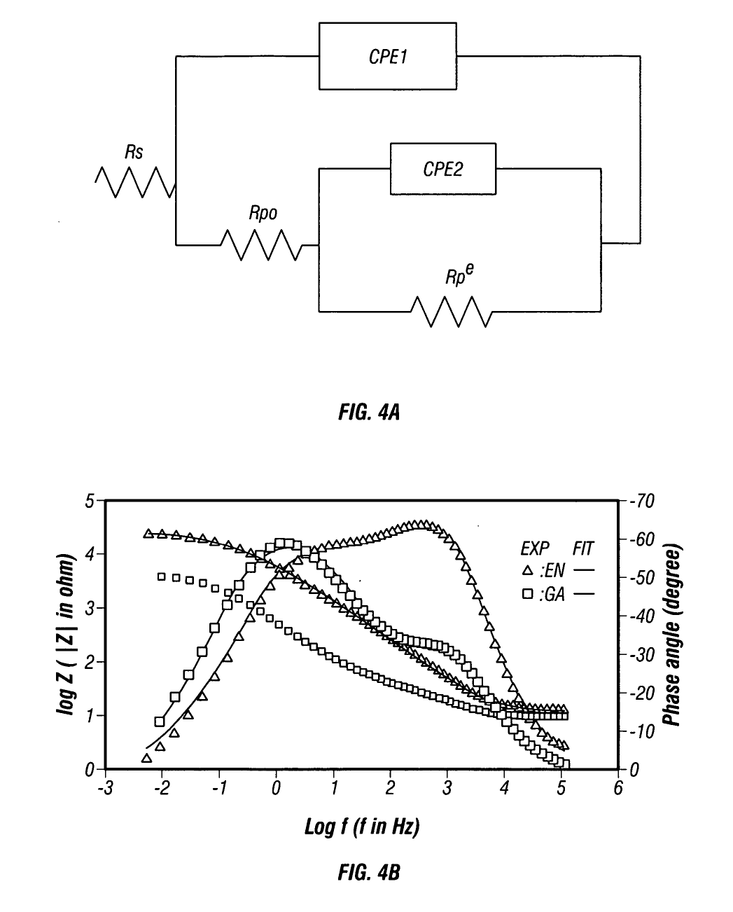

ECs and Bode plots for the three treated samples exposed to 0.5N NaCl for 1 day are shown in FIG. 3 and FIG. 4. The fit parameters are listed in Table III. The EC in FIG. 3 for treated EG has two CPEs in parallel with Rₚ^{e} which is in series with the OFLD.

The first CPE is related to the surface layer capacitance and the second CPE is related to the capacitance of the bare surface exposed in the pores. The pore resistance, Rₚₒ indicates the coating porosity. Rₚ^{e} is the polarization resistance of the bare surface. The equivalent circuit (EC) and the Bode plots for treated EN and GA exposed to 0.5N NaCl for 1 day are shown in FIG. 4 and the fit parameters are listed in Table III. The EC in FIG. 4 has two parallel CPEs, Rₚₒ and Rₚ^{e}.

A comparison of the fit parameters for bare (Table II) and treated (Table III) EG shows an increase of Rₚ^{e} and σ and a decrease of B_{d} for the treated EG. This may be due to a decrease of the exposed surface area at which active corrosion occurs. The observed decrease of B_{d} could be due to a coating layer that is thinner than the corrosion product layer on the untreated sample. The values of the Yₒ parameters and the inverse values of Rₚ^{o} for the treated samples follow the same trends as the i_{corr} values obtained from analysis of the polarization curves.

The i_{corr} and P values from polarization curves and EIS data are shown in Table IV. Very good agreement is found for both parameters that are obtained with two independent techniques. The data demonstrate again that the surface chemistry of the galvanized steels plays an important role in the corrosion resistance of bare and treated samples.

Based on the assumption that the specific R^{o}_{P}=RₚxA_{corr} values for the exposed area of the galvanized steel, where A_{corr} is the corroding area, are the same for treated and untreated samples, the change of the corroding area ΔA_{corr} due to treatment can be estimated as:
ΔA_{corr}=(R_{p,tr}−R_{p,b})/R_{p,tr} (4)
where R_{p,tr} and R_{p,b} are the Rₚ values for treated and untreated samples, respectively.

Based on the results shown in Tables II and III ΔA_{corr} values are 88.8%, 63.87% and 11.39% for EG, EN and GA, respectively. This result is in agreement with the P values in Table IV.

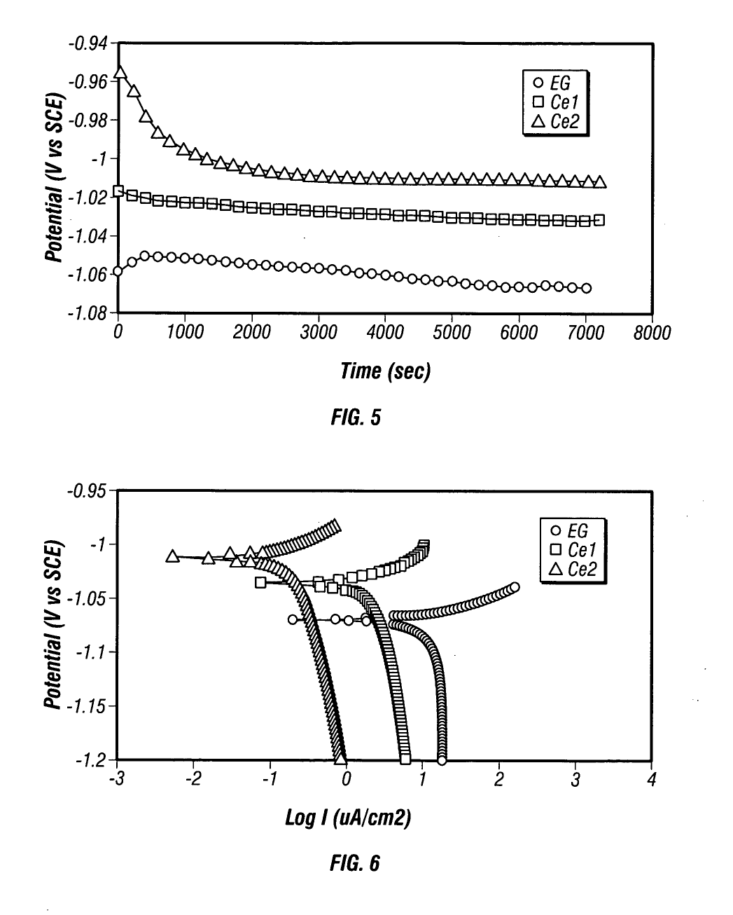

XPS analysis is used in order to better understand the chemical composition of the coatings. The XPS spectra for treated samples after 2 min sputtering with Ar⁺ (sputtering rate: 0.13 nm/sec) are shown in FIG. 5 to FIG. 7. A satellite peak for Ce⁺4 appears at 917 eV. The peaks for Ce3d_{3/2} and Ce3d_{5/2} imply that the major component of coating layer on EG is Ce³⁺ (FIG. 5a). In the spectra for O 1s, peaks for OH⁻ and O₂− appear at 532.6 and 530.1 eV, respectively (FIG. 5b). The chemical state of oxygen in the coating layer on the EG is mostly O²⁻ with some OH—. A peak for Zn²⁺ appears at 1022.7 eV in the spectra for Zn2p_{3/2} (FIG. 5c).

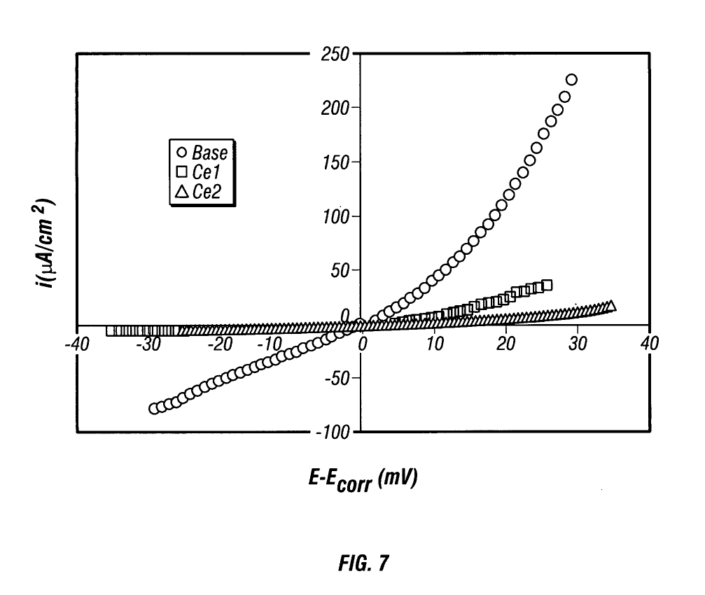

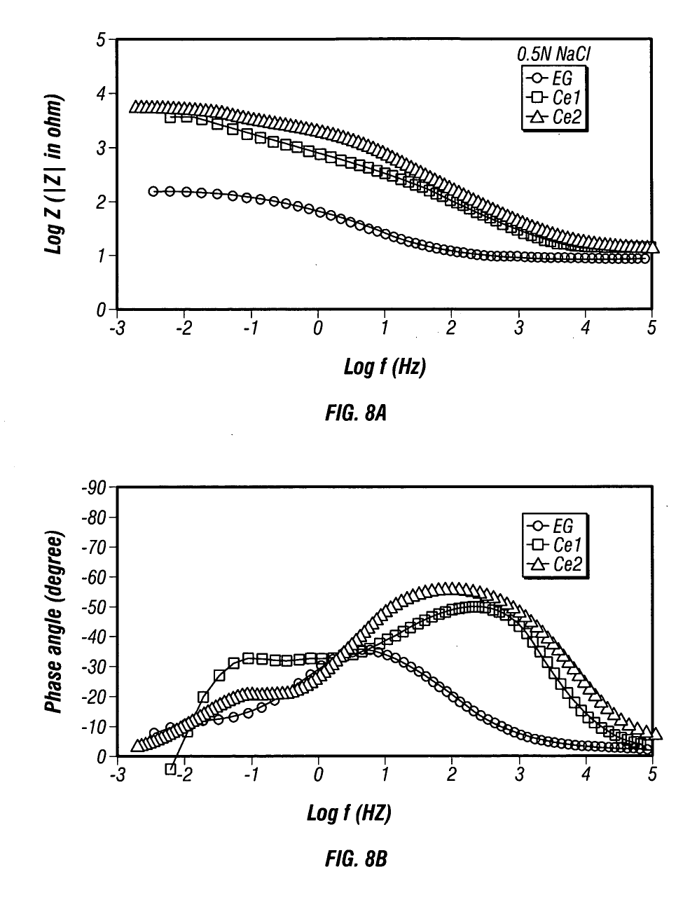

Based on these results, it can be seen that the coating layer on the EG is formed mainly of Ce³⁺—O²⁻ with some Ce⁺⁴—Zn²⁺—OH⁻. The XPS results for the coating layer on EN are shown in FIG. 6. The chemical state of Ce in the coating layer on the EN is mainly Ce³⁺ with a small amount of Ce⁴⁺ (FIG. 6a). The chemical state of oxygen is mostly O²⁻ (FIG. 6 b) and the chemical state of Zn is Zn²⁺ (FIG. 6b). The Ni 2p_{3/2} peak in the spectra was not detected, which means that Ni does not react with the cerium salt solution. The main chemical state of Ce in the coating layer on GA is Ce³⁺ (FIG. 7 a). While the chemical state of oxygen in the coating layers on EG and EN is mainly O²⁻, that on GA is equally composed of OH⁻ and O²⁻ (FIG. 7b). The Zn in the coating layer on GA exists as Zn²⁺ probably as Zn(OH)₂ (FIG. 7c). An Al 2p peak was detected in the coating layer (FIG. 7d), however a Fe peak was not found.

The chemical composition of the coating layers is determined by integration of the peak area in the spectra. The chemical composition of the coating layer depends on the substrate chemistry (Table V). Therefore, the corrosion protection provided by the coating layers as expressed by i_{corr} and P is related to the chemical composition of the layer. Treated EG and EN have high amounts of Ce³⁺ and Ce⁴⁺ mainly combined with O²⁻. The coating layer on GA that has low amounts of Ce and high amounts of Zn combined with OH⁻ and O² shows low P value. Although the total amount of Ce in the coatings is lower for treated EG than that for treated EN, the P value for treated EG is higher than that for treated EN, which could be explained with different coating thickness and Ce⁴⁺ concentration. The coating on EG is thicker than that on EN, which explains why the P value for treated EG is higher. This assumption is supported by the value of the diffusion length for treated EG estimated from the B_{d} value (Table III). This supports that the corrosion protection provided by a coating layer on Al is improved by the presence of Ce⁴⁺ as CeO₂. Based on Table V, the amount of Ce⁴⁺ in the layer on treated EG is higher than that for treated EN. Apparently, the P value is determined by a combination of coating thickness and chemical state of Ce in the coating layer.

For this first embodiment, the corrosion resistance of untreated and treated galvanized steel depends strongly on the surface chemistry. The Zn—Ni samples have the lowest corrosion rates with and without treatment in the basic solution. Viewed in terms of the protection efficiency P, the greatest reduction in corrosion rates due to the cerium salt treatment was found for the electrogalvanized sample with P=95.8%. Similar results are obtained by assuming that treatment in the cerium salt solution reduces the area at which active corrosion occurs. The protection efficiency was shown to be related to the amount of cerium in the coating layer. The surface layer on hot dipped galvanized steel which had the poorest corrosion resistance contained mainly zinc hydroxide.

### Second Embodiment

In another embodiment, a special chromate-free process which may be applicable for home appliances is described. This process prevents the appearance of white rust on electrogalvanized steel in a salt spray test.

In this process the electrogalvanized steel is dipped for 10 seconds into a solution of cerium salt—here 20 mM Ce(NO₃)₃, which also includes 20 g/L H₂O₂, 30 g/L of colloidal silica, and 30 g/L of silane. The wet sample is then placed in an oven at 1200 for 60 seconds. Tests comparing the treated sample with an untreated sample during exposure to 0.5N NaCl for seven days have shown a protection efficiency between 91% and 96%. This material has also been analyzed using surface analytical techniques, and it has been found that the conversion film was a Ce—Si—O—C complex. One advantage of this embodiment is that the corrosion resistance can be in proved in a very short time.

### Third Embodiment

In another embodiment, the EG material contains a zinc coating with a thickness of 3-4 μm on a low-carbon steel with a thickness of 0.8 mm. The resulting sheets are cut into 3½×7 cm specimens. As in other embodiments, the substrates are then cleaned in an Alconox detergent solution using an ultrasonic cleaner for 10 minutes. The materials are then rinsed with purified water. In the embodiment, the substrates are treated with two different processes, denoted as CE1 and CE2.

CE1 dips the sample into a cerium salt solution: 10 mM Ce(NO₃)₃ for 30 minutes at room temperature, then rinses with purified water and dries by air blowing.

CE2 dips the sample for 60 seconds into the cerium salt solution containing hydrogen peroxide, colloidal silica and silane, e.g. glycidoxy propyltri methoxy silane, then dries it in a convection oven for 10 seconds at 120° C.

An important feature of CE2 is that the total treatment time is 70 seconds in the embodiment. More generally, exposure to the cerium salt solution may be for 5 minutes or less, and the drying may again be 5 minutes or less. Therefore, more generally, the total treatment time can be less than 5 minutes.

Table VI shows the test matrix which shows the details of the treatment conditions.

Tests are carried out in a three-electrode cell similar to that described above in the first embodiment. The area of the working electrode is 4.9 cm². A saturated calomel electrode (SCE) and a stainless steel plate are used as reference and counter electrode, respectively, as in the first embodiment. The protective properties of the Ce-based films formed in the Ce1 and Ce2 processes are evaluated during exposure to 0.5 N NaCl (open to air) for 7 days using corrosion potential (E_{corr}), EIS and potentiodynamic polarization measurements. Impedance spectra are recorded at E_{corr} in a frequency range between 10⁵ and 5×10⁻³ Hz with an applied ac signal of 10 mV. The spectra are analyzed using suitable equivalent EC models. Following the recording of an impedance spectrum, a potential sweep with a scan rate of 0.167 mV/s is performed in the potential range between −30 mV and +30 mV from E_{corr}. The polarization curves are analyzed using the POLFIT software as above.

The polarization resistance Rₚ^{e} values obtained by analysis of the EIS data are converted into i_{corr}^{e},
I_{corr}^{e}=B/Rₚ^{e} (5)

The total charge Q, in the units of Coloumb/cm² is obtained by graphical integration of the i_{corr} time curves:
Q=∫i_{corr}dt (6)

The protection efficiency P is defined as:
P=(Q^{o}−Q)/Q (7)
where Q^{o} is the value for untreated EG and Q is the corresponding value for a treated sample.

Coating structure and evaluation of corrosion resistance

The microstructure of the Ce-based conversion coating layers formed on the EG was observed using a SEM (Hitachi, S430). The chemical composition of the coating layers was analyzed using SAM (Scanning Auger Microscopy PH40 l, Perkin Elmer) depth profiling with Ar⁺ ion sputtering at a rate of 1.1 nm/min for 0-30 min and 8.9 nm/min for 30-50 min. In order to determine the corrosion resistance of the treated samples, the salt spray test was carried out according to ASTM B117. The edges of the samples were tightly sealed by vinyl tape to prevent any edge effects. Bare and treated samples were placed into a salt spray cabinet for 72 h and compared by visual inspection at the end of the test for the purpose of corrosion resistance evaluation.

Results and Discussion

Electrochemical Tests

The E_{corr} values of the bare and treated samples (EG, Ce1, and Ce2) were monitored in 0.5 N NaCl for two hours and are shown in FIG. 5. After exposure for two hours, E_{corr} for EG was about −1.06 V vs. SCE, while E_{corr} for the treated samples was more positive by more than 40 mV. The anodic and cathodic polarization curves obtained wide in a fairly potential region are shown in FIG. 6. The limiting current density (c. d.) for oxygen reduction for the treated samples is decreased compared to that for the untreated EG.

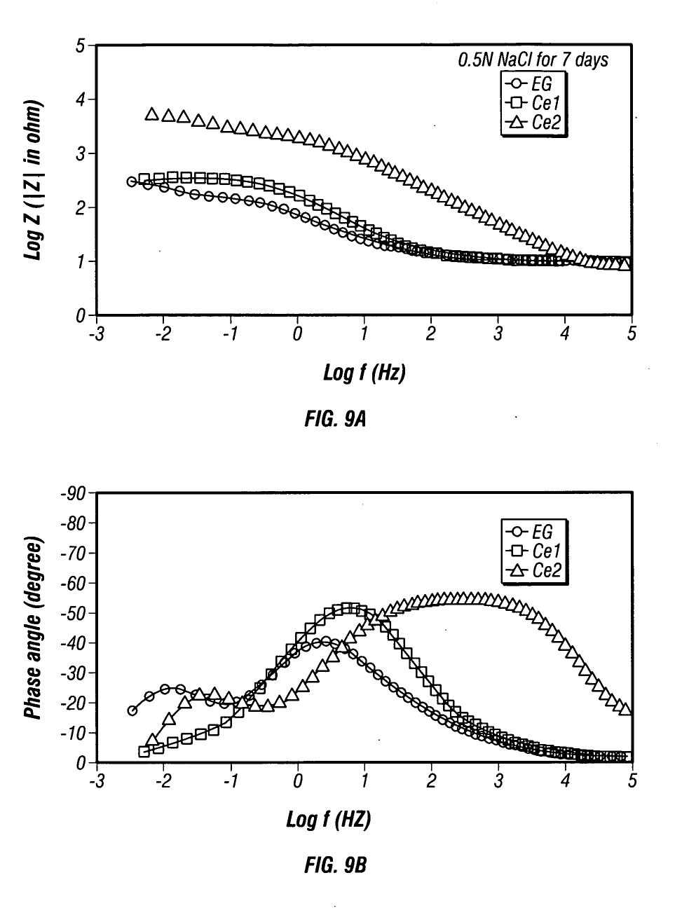

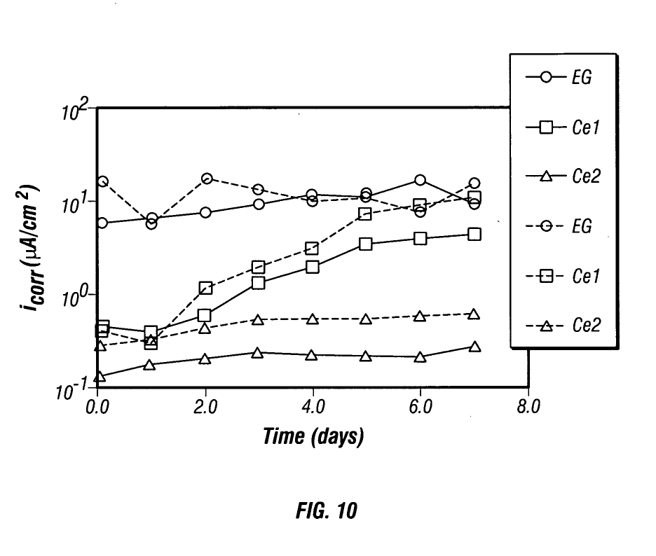

The anodic c. d. for the coated samples also decreased, which suggests that the corrosion protection provided by the Ce conversion is due to reduction of the rate of both the anodic and the cathodic reactions. This is most likely due to the reduction of the area that is not covered by the conversion coating. Corrosion current density, I_{corr} and Tafel slopes for the three samples are obtained by analysis of the polarization curves obtained in the vicinity of E_{corr} (FIG. 7) with the POLFIT program. Qualitatively FIG. 7 shows a large difference in Rₚ which is defined as the slope of the E-I curve at i=0 for the treated and untreated samples. Bode plots for 2 and 7 days obtained for bare and treated samples exposed to 0.5N NaCl are shown in FIG. 8 and FIG. 9, respectively. For bare EG, one time constant was found for 2 days exposure (FIG. 8) and two time constants are observed for 7 days (FIG. 9). The spectra for the sample treated in the Ce1 process showed one time constant after 2 and 7 days. For exposure for one day a very large decrease of the capacitance and an increase of Rₚ, are observed for the treated samples (FIG. 8). For exposure for 7 days the difference in the impedance values for the bare sample and the sample treated in the Ce1 process had become much smaller suggesting that the degree of corrosion protection provided by the Ce1 process had decreased.

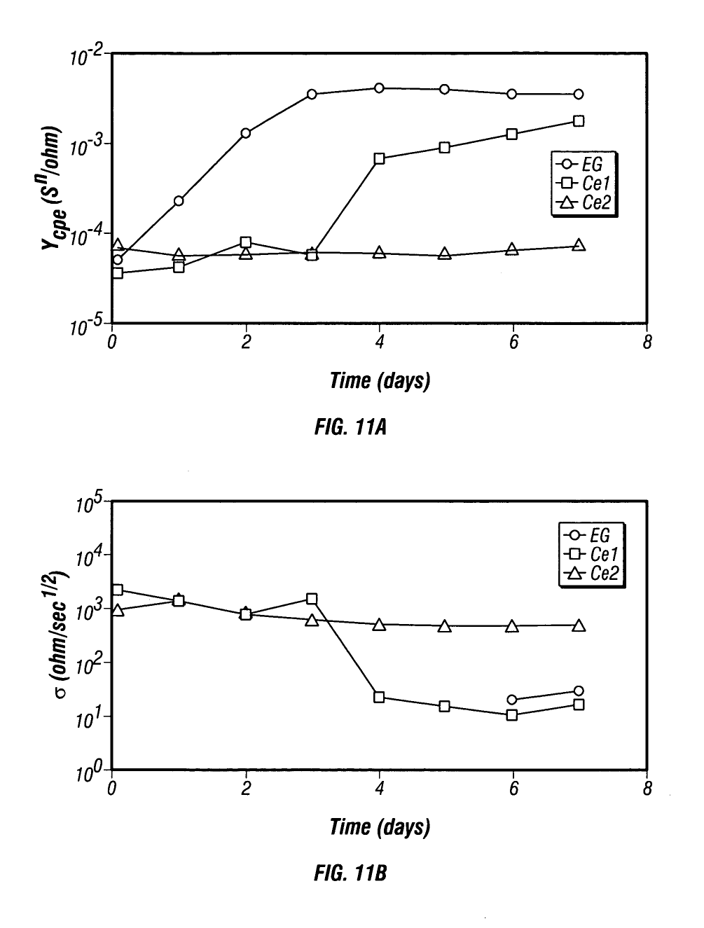

The EC containing a constant phase element (CPE) and the open boundary finite length diffusion (OFLD) element is used to analyze the impedance spectra for bare and treated samples that show two time constants. The i_{corr} values obtained from the polarization curves using POLFIT and i_{corr}^{e} (Eq. 5) converted from Rₚ^{e} are shown in FIG. 10. FIG. 10 illustrates the large difference in the corrosion rates of the bare sample and the sample treated in the Ce2 process. In both cases I_{corr} increases slowly with time (FIG. 10). For the sample treated in the Ce1 process (immersion in Ce(NO₃)₃ only i_{corr} values were initially similar to those found for the samples treated in the Ce2 process, however after 7 days i_{corr} values were similar to those for the untreated sample (FIG. 10).

FIG. 10 shows a tendency towards an underestimation of i_{corr} obtained by the polarization method can be seen for the treated samples, which is due to the contribution of the solution resistance R, and the mass transport resistance R_{d} to the experimental value Rₚ^{exp} of the polarization resistance:
Rₚ^{exp}=Rₛ+Rₚ+R_{d}+Rₚ+B_{d}/Yₒ [8]
where R_{d}=B_{d}/Yₒ, i.e. the dc limit of Z_{OFLD}. These effects can be corrected. However, without correction of these effects, the calculated i_{corr} values will be smaller than the true values. The same holds true for the Q values determined based on Eq. 6.

The Q and P values for the bare sample and the two treated samples are listed in Table VII. The sample treated in the Ce2 process showed excellent corrosion resistance with Q values of 98.1% (polarization data) and 95.8% (EIS data).

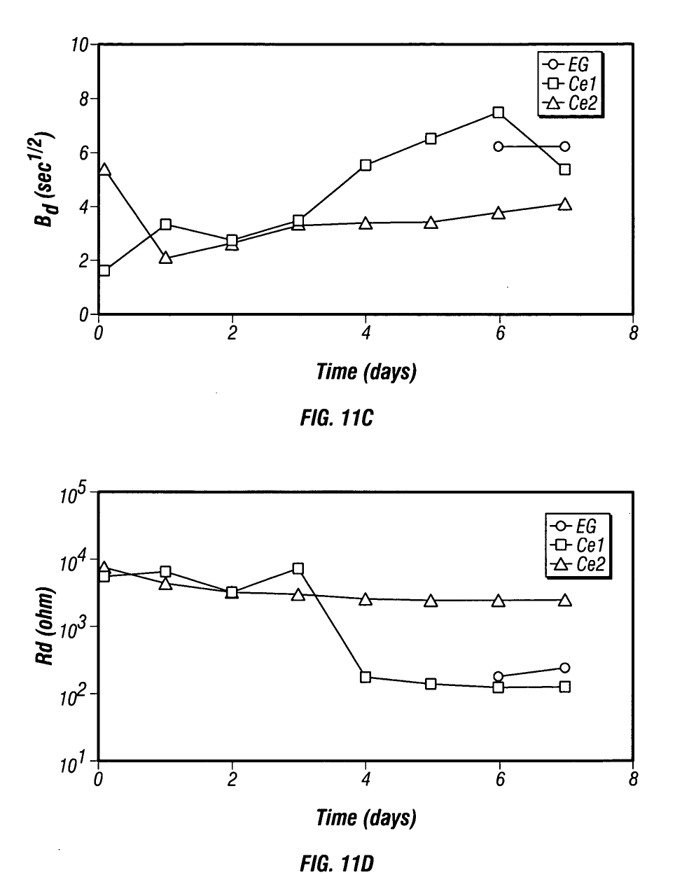

The time dependence of the CPE parameter Y_{cpe} for bare and treated samples is shown in FIG. 11a. For the untreated sample (EG) Y_{cpe} initially increased and then became constant after about 4 days. This increase is believed due to the increase of the true surface area as white rust is formed. The Y_{cpe} values for the two treated samples initially are quite similar, but after 3 days Y_{cpe} increased for the sample treated in the Ce1 process (FIG. 11a).

The time dependence of Warburg coefficient σ for bare and treated samples is shown in FIG. 11b. For the untreated sample, the OFLD model was used only for analysis of the data collected after 6 and 7 days. For the first 3 days of exposure σ had similar values for the two treated samples, but after 4 days a had decreased significantly similar to the observed increase of Y_{cpe} (FIG. 11a). For exposure for 6 and 7 days σ had similar values for the untreated sample and the sample treated in the Ce1 process (FIG. 11b). Similar to the values of Y_{cpe} and σ, the values of B_{d} initially are quite similar for the two treated samples (FIG. 11c). However, after exposure for 3 days, B_{d} increased continuously for the sample treated in the Ce1 process with a much smaller increase for the sample treated in the Ce2 process.

The diffusion resistance R_{d} (FIG. 11d) also showed a sharp drop for the sample treated in the Ce1 process after 3 days reflecting the loss of corrosion protection provided by this coating layer.

The results shown in FIG. 11 indicate that the loss of corrosion protection provided by the coating formed in the Ce1 process after exposure for 3 days is reflected in an increase of Y_{cpe} and B_{d} and a decrease of σ and R_{d}.

Coating Structure

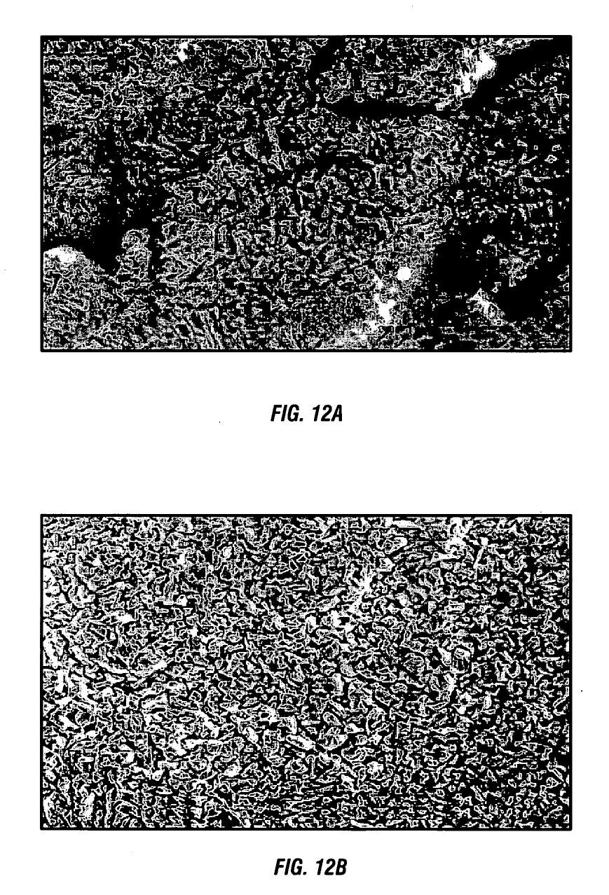

The surface morphology of the treated samples may be observed by SEM. The microstructure of EG treated in the Ce1 process is similar to the original hexagonal microstructure of electroplated Zn, which indicates that the layer formed on the electroplated Zn in the Ce1 process is quite thin (FIG. 12a). A thicker coating layer must have been formed in the Ce2 process since the microstructure of the untreated electroplated Zn was not observed clearly (FIG. 12b).

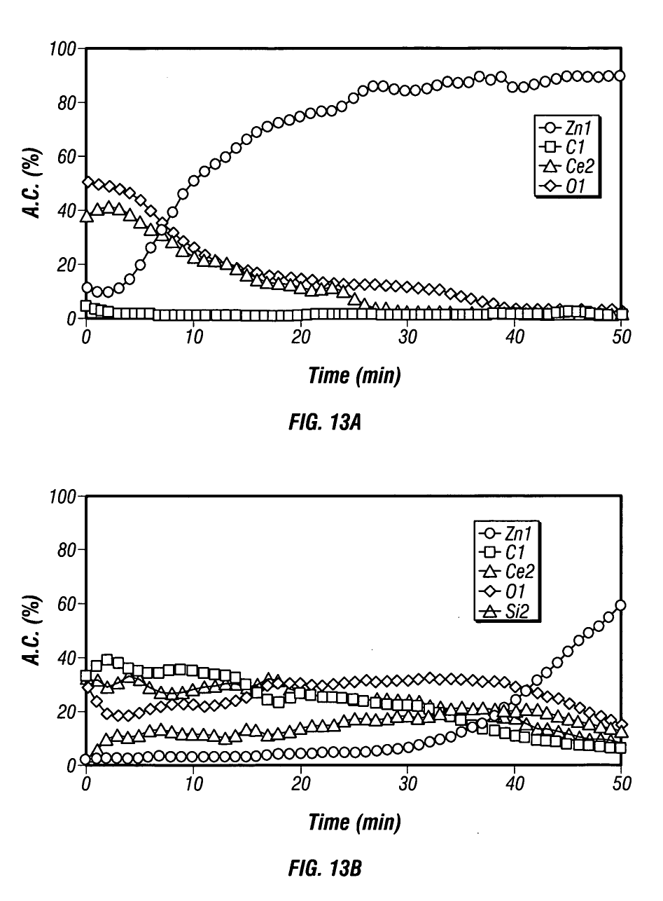

SAM depth profiling analyses are performed to identify the chemical composition of the coating layers formed in the Ce1 (FIG. 13a) and Ce2 processes (FIG. 13b). Peaks for Ce and O for the sample treated in the Ce1 process are detected from 0 to 10 min, which indicates that a Ce-oxide film with a small amount of Zn is formed on the electroplated Zn surface. The results of SAM depth profiling for the sample treated in the Ce2 process are quite different from those for the sample treated in the Ce1 process. Peaks for C, Ce, Si and O are detected from 0 to 40 min suggesting that the film formed in the Ce2 process is thicker. Due to the large surface roughness of the EG sample (FIG. 12a), it is very difficult to determine reasonable film thickness values based on the sputtering data. The peaks for C and Si are assumed to be from incorporation of silane and colloidal silica, respectively, in the protective surface layers.

The role of the different additives seems to be that hydrogen peroxide controlled the ratio of Ce³⁺/Ce⁴⁺ in the solution, colloidal silica acted as an anticorrosive additive due to its hydrophobic effect and silane blocked the defects in the conversion coating.

Salt Spray Test

To verify the degree of corrosion protection provided by the Ce-based conversion films formed in the Ce1 and Ce2 processes, the salt spray test based on ASTM B-117 was performed for bare EG and treated samples. The surface of the untreated EG was completely covered with red rust within 5 h. The surface of the sample treated in the Ce1 process was covered with white rust with in 24 h, however the surface of the sample treated in the Ce2 process did not show white rust up to 72 h, which meets the industrial standard for home appliances.

The corrosion resistance of bare EG can be improved by immersion in 10 mM Ce(NO₃)₃ for 30 minutes, however the results of polarization and EIS tests show that the corrosion resistance decreased significantly after immersion in 0.5 N NaCl for about 3 days. An improved Ce-based conversion coating process adds hydrogen peroxide, colloidal silica, silane and drying at 120° C. with a reduced treatment time of less than 5 minutes—and preferably for only 70 seconds. The polarization curve for the sample treated in the newly developed Ce-based conversion coating process showed a reduction of the rates of the anodic and the cathodic reaction which is considered to be due to a reduction of the area exposed in the pores of the coating at which corrosion occurs.

The coating structure produced in the Ce2 process is identified as a Ce—C—O—Si complex. A synergetic effect of the different additives makes the Ce-based conversion coating layer thicker and denser by blocking defects in the layer resulting in improved corrosion resistance. The Ce2 sample withstood 72 h without white rust in the salt spray cabinet, which shows that the new Ce-based conversion film formation process is a promising candidate for replacing the presently used conventional chromate treatments.

Another embodiment uses these techniques with other galvanized steels such a hot dip galvanized steel, Zn—Ni and Zn—Fe.

TABLE I
Parameters calculated with POLFIT program

| | E_{corr} | i_{corr} | bₐ | b_{c} | B | P |
|---|---|---|---|---|---|---|
| | (mV) | (μμA/cm²) | (mV) | (mV) | (mV) | (%) |
| Bare | | | | | | |
| EG | −1097 | 6.85 | 35 | 74 | 10.3 | — |
| EN | −878 | 0.40 | 53 | 367 | 20.0 | — |
| GA | −943 | 0.54 | 59 | 47 | 11.5 | — |
| Treated | | | | | | |
| EG | −1059 | 0.18 | 14 | 101 | 5.5 | 95.8 |
| EN | −805 | 0.15 | 62 | 160 | 19.5 | 62.4 |
| GA | −896 | 0.39 | 38 | 55 | 9.7 | 27.8 |

TABLE II
Fit parameters for EIS data for bare substrates

| | | | | OFLD | | |
|---|---|---|---|---|---|---|
| | Yₒ | | Rₚ^{e} | σ | B_{d} | i^{e}_{corr} |
| | (×10⁻⁴ sⁿ/Ω) | n₁ | (Ω) | (Ω/sec^{1/2}) | (sec)^{1/2} | (μμA/cm²) |
| Bare | | | | | | |
| EG | 19.2 | 0.82 | 190 | 10 | 17.4 | 11.1 |
| EN | 0.3 | 0.93 | 8900 | 2400 | 1.6 | 0.45 |
| GA | 2.9 | 0.72 | 4230 | 50 | 8.9 | 0.55 |

TABLE III
Fit parameters for EIS data for treated substrates

| | | | | | | OFLD | |
|---|---|---|---|---|---|---|---|
| Yₒ¹ | | Rₚₒ | Yₒ² | | Rₚ^{e} | σ | B_{d} |
| (×10⁻⁴ sⁿ/(Ω)) | N₁ | (Ω) | (×10⁻⁴ sⁿ/(Ω)) | n₂ | (Ω) | (Ω/sec^{1/2}) | (sec)^{1/2} |

Treated

| | | | | | | | | |
|---|---|---|---|---|---|---|---|---|
| EG | 0.62 | 0.75 | 470 | 1.04 | 0.73 | 1700 | 2200 | 2.4 |
| EN | 0.13 | 0.85 | 620 | 0.36 | 0.62 | 24600 | — | — |
| GA | 1.21 | 0.74 | 44 | 3.74 | 0.73 | 4230 | — | — |

TABLE IV
Comparison of data obtained from polarization curves and
impedance spectra

| | |
|---|---|
| Polarization curves | EIS |

| | i_{corr} | P | i^{e}_{corr} | P^{e} |
|---|---|---|---|---|
| | (μA/cm²) | (%) | (μA/cm²) | (%) |
| Bare | | | | |
| EG | 6.85 | — | 11.06 | — |
| EN | 0.40 | — | 0.45 | — |
| GA | 0.54 | — | 0.55 | — |
| Treated | | | | |
| EG | 0.18 | 95.8 | 0.66 | 94.1 |
| EN | 0.15 | 62.4 | 0.20 | 55.5 |
| GA | 0.39 | 27.8 | 0.41 | 16.3 |

TABLE V
Chemical composition of coating layers on galvanized steel sheet
(atomic %)

| | Ce⁺³ | Ce⁺⁴ | Zn | O | Al |
|---|---|---|---|---|---|
| Treated | | | | | |
| EG | 69.6 | 4.6 | 14.4 | 11.4 | — |
| EN | 84.5 | 2.3 | 6.1 | 7.1 | — |
| GA | 31.2 | 2.8 | 46.5 | 18.2 | 1.3 |

TABLE I
Test matrix

| | | | Drying |
|---|---|---|---|
| Name | Treatment Solution | Dipping | treatment |
| EG | — | — | — |
| Ce1 | 10 mM Ce(NO₃).6H₂O | 30 minutes | at R.T. |
| Ce2 | 20 mM Ce(NO₃).6H₂O, | 10 seconds | 60 seconds |
| | 20 g/L H₂O₂ + 30 g/L | | at 120 C.° |
| | colloidal silica + 30 g/L silane | | |

TABLE II
Comparison of corrosion values Q, and protection efficiency, P (%)
obtained by polarization and EIS methods for three samples exposed to
0.5 N NaCl

| | |
|---|---|
| Q (Coulomb/cm²) | P (%) |

| Samples | Polarization | EIS | Polarization | EIS |
|---|---|---|---|---|
| EG | 6.9 | 7.5 | — | — |
| Ce1 | 1.3 | 2.8 | 81.5 | 62.6 |
| Ce2 | 0.13 | 0.31 | 98.1 | 95.8 |

What is claimed is:

1. A method, comprising
processing a sample of galvanized metal using a cerium salt solution that adds Ce ions to a surface of the galvanized metal.

2. A method as in claim 1, wherein said processing comprises bringing the metal in contact with the cerium salt solution for less than five minutes.

3. A method as in claim 1, wherein said cerium salt solution includes Ce(NO₃)₃.

4. A method as in claim 3, wherein said cerium salt solution further includes hydrogen peroxide, colloidal silica and silane.

5. A method as in claim 1, wherein said galvanized metal is zinc electroplated steel.

6. A method as in claim 1, wherein said galvanized metal is zinc-nickel electroplated steel.

7. A method as in claim 1, wherein said galvanized metal is zinc-iron-aluminum hot dipped cold rolled steel.

8. A method as in claim 4, wherein said processing produces a surface having at least portions that are covered by a complex of Ce—Si—O—C.

9. A method as in claim 4, wherein said processing comprises first processing the sample in said cerium salt solution for 60 seconds or less, and second drying the processed sample.

10. A method as in claim 1, further comprising characterizing a corrosion behavior of said material.

11. A method as in claim 1, further comprising prior to said processing, treating the samples in an Alconox solution.

12. A method as in claim 1, wherein said processing is carried out in 70 seconds or less.

13. A material, comprising:
a galvanized metal having at least one surface; and
a coating on said at least one surface, said coating including cerium oxide.

14. A material as in claim 13, wherein said coating is primarily a material including CE and O.

15. A method as in claim 1, wherein said galvanized metal is zinc electroplated steel.

16. A material as in claim 13, wherein said galvanized metal is zinc-nickel electroplated steel.

17. A material as in claim 13, wherein said galvanized metal is zinc iron aluminum hot dipped cold rolled steel.

18. A material comprising:
a galvanized material having at least one surface; and
a coating film on said at least one surface, said coating film formed from a Ce—Si—O—C complex.

19. A material as in claim 18, wherein said galvanized material is zinc electroplated steel.

20. A material as in claim 18, wherein said galvanized material is zinc-nickel electroplated steel.

21. A material as in claim 18, wherein said galvanized metal is zinc-iron-aluminum hot dipped cold rolled steel.

22. A method, comprising:
processing a sample of galvanized metal using a solution including cerium nitrate, hydrogen peroxide, colloidal silica, and silane.

23. A method as in claim 22, wherein said processing comprises exposing the sample to the solution for 5 minutes or less.

24. A method as in claim 22, wherein said processing comprises exposing the sample to the solution for 60 seconds or less.

25. A method as in claim 22, wherein said processing forms a Ce—Si—O—C complex.

26. A method as in claim 22, wherein said processing forms a coating which includes CE and O.

27. A method as in claim 16, wherein said cerium nitrate is Ce(NO₃)₃.

28. A method, comprising:
processing a galvanized metal using a cerium nitrate solution, a first additive that controls a ratio of cerium ions in the solution, a second additive that has a hydrophobic effect, and a third additive that blocks defects in a conversion coating.

29. A method as in claim 28, wherein said first additive is hydrogen peroxide.

30. A method as in claim 28, wherein said second additive is colloidal silica.

31. A method as in claim 28, wherein said third additive is silane.

32. A method as in claim 28, wherein said processing occurs in 70 seconds or less.

33. A method, comprising:
processing a sample of galvanized metal using an anticorrosive solution for 60 seconds or less; and then
drying the processed sample in an oven for 10 seconds or less.

34. A method as in claim 33, wherein said anticorrosive solution includes cerium nitrate, hydrogen peroxide, colloidal silica, and silane.
